(19) United States
(12) Patent Application Publication
(10) Pub. No.: US 2009/0007755 A1
(43) Pub. Date: Jan. 8, 2009

(54) Modified drumstick for teaching purposes

(76) Inventor: Timothy J. Rivers, JR., Bridge City, LA (US)

Correspondence Address: JAMES RAY & ASSOCIATES, 2640 Pitcairn Road, Monroeville, PA, 15146, US

(21) Appl. No.: 12/217,607

(22) Filed: Jul. 7, 2008

Related U.S. Application Data
(60) Provisional application No. 60/948,344, filed on Jul. 6, 2007.

(51) Int. Cl. G10D 13/02

(52) U.S. Cl. 84/422.4; 84/453

(57) ABSTRACT

In combination with a drumstick used for playing a drum, the improvement comprises an apparatus for teaching a novice the proper technique for holding a drumstick. The apparatus includes at least one aperture disposed in the drumstick and an elastomeric member engageable with the aperture and having a loop on each side of the drumstick for engagement with a user's thumb and ring finger.

### CROSS REFERENCE TO RELATED APPLICATIONS

This application is closely related to and claims benefit from U.S. Provisional Application Ser. No. 60/948,344 filed Jul. 6, 2007.

### FIELD OF THE INVENTION

The present invention relates, in general, to a drumstick, and, more particularly, the present invention relates to a modified drumstick that has a rubber band type attachment that attaches to the thumb and ring finger so as to teach a user the correct way to hold the drumsticks.

### BACKGROUND OF THE INVENTION

Most people do not have the time to learn to learn to play the drums through instructional videos or hundred-page manuals. People want to play now. This is probably even truer when the individual is a youngster who need to see progress immediately.

Books can take years to get through and the videos are abstract and show paid professionals doing things that the novice may not be capable of yet. And unless the user is a virtuoso, self-education does not always pan out. A genuinely hands-on approach to playing the drums (a hands-on instrument) does not exist. It is important for the user to get immediate results so as to keep interest at a peak.

Thus, it would be advantageous if there were a simple and effective means for learning to play the drums and as a first start to learn how to hold the drumsticks correctly.

### SUMMARY OF THE INVENTION

In a first aspect the present invention provides in combination with a drumstick used for playing a drum, the improvement comprises an apparatus for teaching a novice the proper technique for holding a drumstick. The apparatus includes at least one aperture disposed in the drumstick and a securing means engageable with the aperture and having a loop on each side of the drumstick for engagement with a user's thumb and ring finger.

### OBJECTS OF THE INVENTION

It is, therefore, one of the primary objects of the present invention to provide an apparatus for teaching a user the correct position for holding a drumstick.

Another object of the present invention is to provide an apparatus that provides loops on each side of such drumstick for a thumb and ring finger.

Still another object of the present invention is to provide an apparatus wherein such loops are provided by a rubber band.

Yet another object of the present invention is to provide an apparatus wherein such loops are removable when such user has mastered such proper position for holding a drumstick.

In addition to the various objects and advantages of the invention which have been described in some specific detail above it should be noted that various other objects and advantages of the present invention will become more readily apparent to those persons who are skilled in the relevant art from the following more detailed description, particularly when such description is taken in conjunction with the appended claims.

### BRIEF DESCRIPTION OF THE DRAWINGS

FIG. 1 is a top perspective view of the combination showing a drumstick with such securing means showing a loop disposed on each side of the drumstick.

FIG. 2 is a is a perspective view of the combination shown in FIG. 1 wherein such securing means includes a rubber band.

FIG. 3 is a top perspective view of the combination showing a user's hand holding a drumstick with the securing means engaged to such user's finger and thumb.

FIG. 4 is a perspective view of the drumstick showing the plurality of apertures disposed therein.

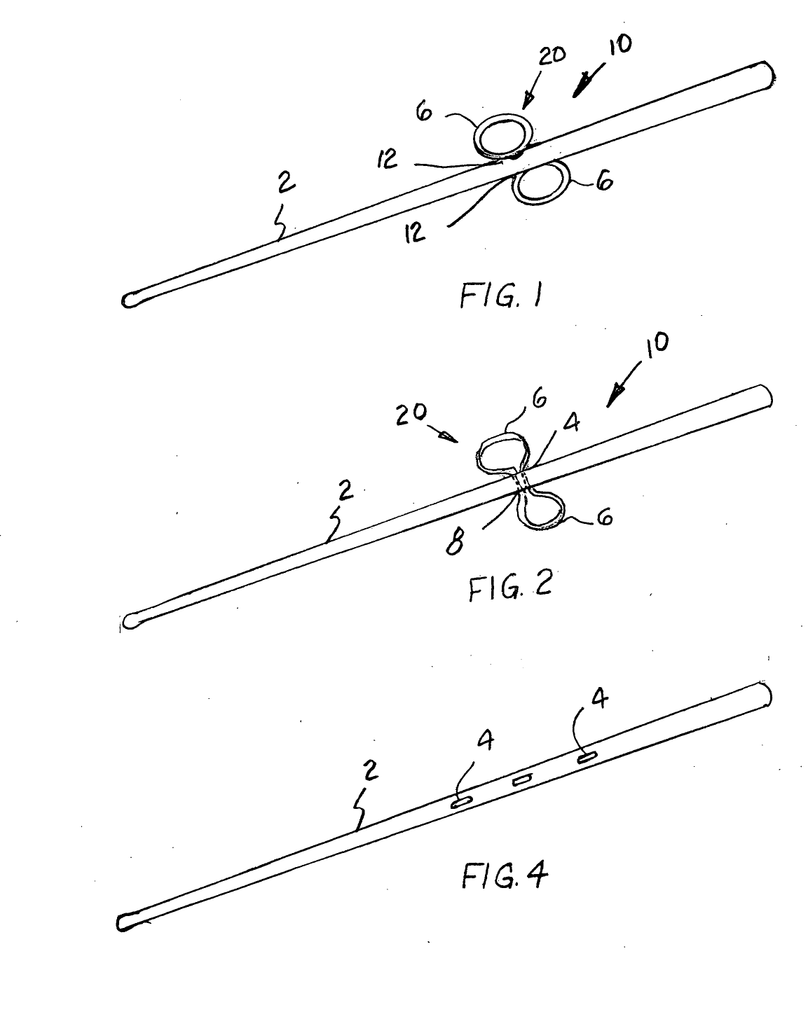

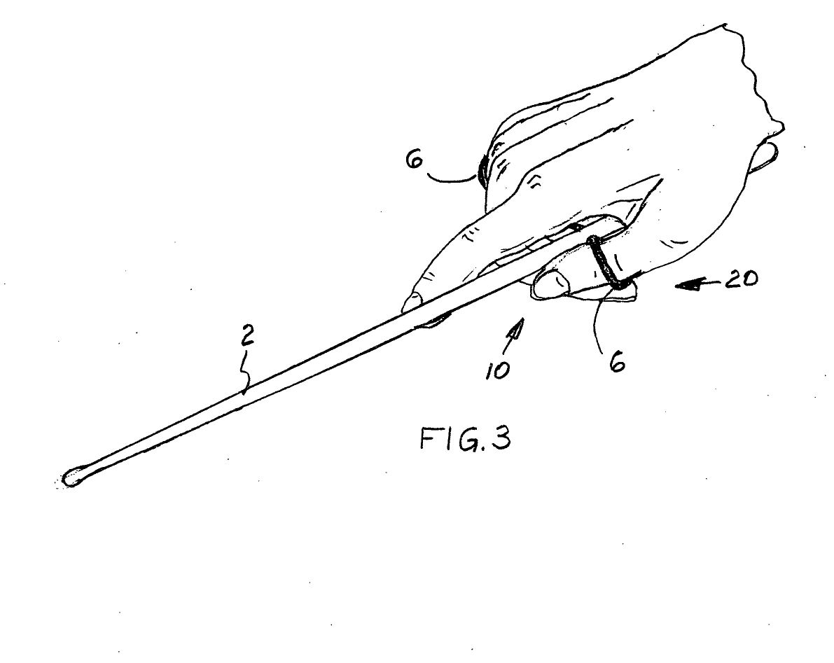

### BRIEF DESCRIPTION OF THE PRESENTLY PREFERRED AND VARIOUS ALTERNATIVE EMBODIMENTS OF THE INVENTION

Prior to proceeding with the more detailed description of the present invention it should be noted that, for the sake of clarity, identical components which have identical functions have been designated by identical reference numerals throughout the several views illustrated in the drawings.

In a first aspect the present invention provides in combination with a drumstick 2 used for playing a drum, the improvement comprises an apparatus, generally designated 10, for teaching a novice the proper technique for holding a drumstick 2. The apparatus 10 includes at least one aperture 4 disposed in the drumstick 2 and a securing means, generally designated 20, engageable with the aperture 4 and having a loop 6 disposed on each side of the drumstick 2 for engagement with a user's thumb and ring finger.

The securing means 20 is an elastomeric band disposed through the aperture 4 of drumstick 2 and forming a loop 6 on each side of drumstick 2. In an embodiment of the invention such securing means 20 is a rubber band 8, wherein such rubber band is pulled through the aperture and forms a loop 6 on each side of the drumstick 2.

In another embodiment of the invention such securing means 20 includes a pair of O-rings 12 connected to each other through such aperture 4. It is presently preferred that such drumstick 2 have a plurality of apertures 4 disposed therein. Such plurality of apertures 4 permits such user to set proper positioning of a fulcrum point for each such user since there is a difference in the size of the hands for most users and also this then can be used for novices that are of different ages and therefore have different sized hands.

It is presently preferred that such combination includes two drumsticks 2, one for each hand so that both hands will learn the proper technique for holding a drumstick 2 at the same time.

Such rubber band 8 or such O-rings 12 are removably engageable with the aperture 4 in such drumstick 2. Thus, such securing means 20 can be removed when such user has mastered such proper technique for holding a drumstick.

It should be noted that the securing means 20 will remain in place as the securing means 20 is held in place with such user's finger and thumb while in use.

While a presently preferred embodiment and alternate embodiments of the present invention have been described in detail above, it should be understood that various other adaptations and/or modifications of the invention can be made by those persons who are particularly skilled in the art without departing from either the spirit of the invention or the scope of the appended claims.

I claim:

1. In combination with a drumstick used for playing a drum, the improvement comprising an apparatus for teaching a novice the proper technique for holding a drumstick, said apparatus including:
(a) at least one aperture disposed in said drumstick; and
(c) a securing means engageable with said aperture and having a loop on each side of said drumstick for engagement with a user's thumb and ring finger.

2. The combination, according to claim 1, wherein said securing means is an elastomeric band disposed through said aperture of said drumstick and forming said loop on each side of said drumstick.

3. The combination, according to claim 2, wherein said securing means is a rubber band.

4. The combination, according to claim 2, wherein said securing means includes a pair of O-rings connected to each other through said aperture.

5. The combination, according to claim 1, wherein said combination includes two drumsticks.

6. The combination, according to claim 1, wherein said drumstick has a plurality of apertures disposed therein.

7. The combination, according to claim 5, wherein said plurality of apertures permits such user to set proper positioning of a fulcrum point for such user.

8. The combination, according to claim 3, wherein said rubber band is removably engageable with said aperture in said drumstick.

9. The combination, according to claim 4, wherein said pair of O-rings are removably engageable with said aperture in said drumstick.

10. The combination, according to claim 1, wherein said securing means is removed when such user has mastered such proper technique for holding a drumstick.

11. The combination, according to claim 1, wherein said securing means will remain in place as said securing means held in place with such user's finger and thumb while in use.
